(19) United States
(12) Patent Application Publication
(10) Pub. No.: US 2013/0100165 A1
(43) Pub. Date: Apr. 25, 2013

(54) IMAGE PROCESSING APPARATUS, METHOD FOR CONTROLLING THE SAME, AND PROGRAM THEREFOR

(71) Applicant: Canon Kabushiki Kaisha, Tokyo (JP)

(72) Inventor: Tomoaki Komiyama, Kawasaki-shi (JP)

(73) Assignee: CANON KABUSHIKI KAISHA, Tokyo (JP)

(21) Appl. No.: 13/656,914

(22) Filed: Oct. 22, 2012

(30) Foreign Application Priority Data
Oct. 25, 2011 (JP) 2011-234203

(51) Int. Cl. G09G 5/00

(52) U.S. Cl. 345/634

(57) ABSTRACT

An image processing apparatus includes an acquisition unit, a display control unit, and a determination unit. The acquisition unit acquires information about a plurality of markers included in an image. The display control unit performs control to superimpose on the image and display on a display unit a plurality of virtual objects corresponding to the plurality of markers. The determination unit determines whether the plurality of virtual objects is a specific combination. In response to the determination unit determining that the plurality of virtual objects is a specific combination, the display control unit performs control to superimpose on the image the plurality of virtual objects in a specific arrangement corresponding to the specific combination.

### BACKGROUND OF THE INVENTION

1. Field of the Invention

The present invention relates to an image processing apparatus, a method for controlling the image processing apparatus, and a program therefor.

2. Description of the Related Art

In recent years, diverse services using the augmented reality (AR) technique have been provided. For example, the use of the AR technique allows superimposing information corresponding to a position of the real world on a captured image of the real world. Services based on the AR technique include enabling a user to view an image as if furniture and household appliances actually exist in his or her room. For example, it has been difficult to actually arrange large-sized furniture and household appliances such as a bed, sofa, refrigerator, and washing machine in a room to confirm their arrangement positions and atmosphere.

To solve this problem, by using the AR technique, the user can perform without burden such works as “measuring an actual size of a piece of furniture or a household appliance and checking whether it fits into a target position” and “simulating whether the furniture or household appliance harmonizes with others.” However, in a conventional method for achieving augmented reality, an image corresponding to a marker is displayed at a position where a marker on a captured image is recognized. With this method, it may be difficult to produce an augmented reality space as intended by the user.

Suppose the user simulates arranging a TV on a TV stand in an augmented reality space. Generally, it is assumed that a TV is arranged on a TV stand and that the user arranges markers considering such an arrangement. However, in the conventional method for achieving augmented reality, since an object is arranged at a marker position, if a TV's marker and a TV stand's marker are simply arranged side by side, the TV and TV stand may be displayed side by side or in an overlapped way. Specifically, in the conventional method for achieving augmented reality, it has been difficult to produce an augmented reality space as intended by the user.

### SUMMARY OF THE INVENTION

The present invention is directed to producing an augmented reality space as intended by the user.

According to an aspect of the present invention, an augmented reality space can be produced much more to the user's intent. According to an aspect of the present invention, an image processing apparatus includes an acquisition unit configured to acquire information about a plurality of markers included in an image, a display control unit configured to perform control to superimpose on the image and display on a display unit a plurality of virtual objects corresponding to the plurality of markers, and a determination unit configured to determine whether the plurality of virtual objects is a specific combination, wherein, in response to the determination unit determining that the plurality of virtual objects is a specific combination, the display control unit performs control to superimpose on the image the plurality of virtual objects in a specific arrangement corresponding to the specific combination.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an image processing apparatus according to a first exemplary embodiment.

FIGS. 2A to 2F illustrate an example of an augmented reality space according to the first exemplary embodiment.

FIG. 3 is a flowchart illustrating operations of the image processing apparatus according to the first exemplary embodiment.

FIG. 4 is a block diagram illustrating an image processing apparatus and an information processing apparatus according to a second exemplary embodiment.

FIG. 5 is a flowchart illustrating operations of the image processing apparatus according to the second exemplary embodiment.

FIG. 6 is a flowchart illustrating operations of the information processing apparatus according to the second exemplary embodiment.

FIG. 7 is a flowchart illustrating operations of an image processing apparatus according to a third exemplary embodiment.

FIG. 8 is a flowchart illustrating operations of an information processing apparatus according to the third exemplary embodiment.

FIG. 9 illustrates a concept of a recommended virtual object table according to the third exemplary embodiment.

FIG. 10 illustrates an example display of a recommended virtual object according to the third exemplary embodiment.

FIG. 11 is a flowchart illustrating operations of an image processing apparatus according to a fourth exemplary embodiment.

### DESCRIPTION OF THE EMBODIMENTS

Various exemplary embodiments, features, and aspects of the invention will be described in detail below with reference to the drawings.

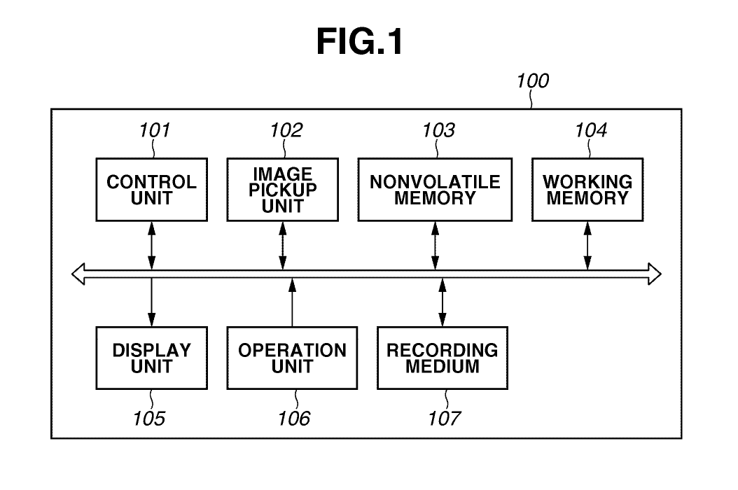

A digital camera, an example of an image processing apparatus capable of producing an augmented reality space, according to a first exemplary embodiment will be described below with reference to FIG. 1. FIG. 1 is a block diagram illustrating a digital camera 100.

A control unit 101 controls each unit of the digital camera 100 according to an input signal and a program (described below). For example, the control unit 101 controls imaging processing, reproduction processing, and logging processing. Each processing will be described below. The digital camera 100 may be controlled by one piece of hardware or a plurality of pieces of hardware taking their share of processing.

An image pickup unit 102 performs the shooting operation to capture an image in the real space. The shooting operation refers to processing for converting into an electrical signal an image of subject's light formed by a lens included in the image pickup unit 102, applying noise reduction processing to the electrical signal, and outputs digital data as image data. The image data output from the image pickup unit 102 can be displayed on a display unit 105 or recorded in a recording medium 107.

A nonvolatile memory 103 stores a program (firmware) for controlling each unit of the digital camera 100 and various setting information. The nonvolatile memory 103 also stores a program used by the control unit 101 to control processing in each flowchart (described below).

A working memory 104 is a memory into which the program stored in the nonvolatile memory 103 is loaded. The working memory 104 is also used as a working area for the control unit 101.

The display unit 105 displays through image data at the time of shooting, captured image data, and text data for interactive operations. In the present exemplary embodiment, the control unit 101 controls each unit of the digital camera 100 to sequentially refresh the image data output from the image pickup unit 102 as a through image and successively display the through image on the display unit 105. By using a program (described below), the control unit 101 superimposes and displays virtual objects on the through image to produce an augmented reality space. Procedures for achieving augmented reality will be described in detail below. The digital camera 100 does not need to be provided with the display unit 105. It is only necessary that the digital camera 100 can be connected with the display unit 105 and have a display control function for controlling the display of the display unit 105.

An operation unit 106 is used by a user to give operation commands to the digital camera 100. The operation unit 106 includes operation members such as a power button to turn the power of the digital camera 1000N and OFF, a release switch for performing the imaging processing, and a playback button for browsing image data.

The image data output from the image pickup unit 102 can be recorded in the recording medium 107. The recording medium 107 stores a virtual object table for achieving augmented reality. The virtual object table stores virtual objects and identification information indicating the virtual objects in an associated way. Virtual objects according to the present exemplary embodiment are, for example, three-dimensional image models of furniture and household appliances. The recording medium 107 also records virtual objects of these three-dimensional image models.

The digital camera 100 according to the present exemplary embodiment detects markers from the through image output from the image pickup unit 102. Then, the digital camera 100 acquires identification information through the detected markers. By checking the acquired identification information in the virtual object table, the digital camera 100 acquires virtual objects indicated by the identification information from the recording medium 107. The acquired virtual objects are displayed at marker positions on the through image. The recording medium 107 may be detachably attached to the digital camera 100 or included in the digital camera 100. Specifically, the digital camera 100 needs to be provided with at least a method for accessing the recording medium 107.

The configuration of the digital camera 100 according to the present exemplary embodiment has specifically been described above.

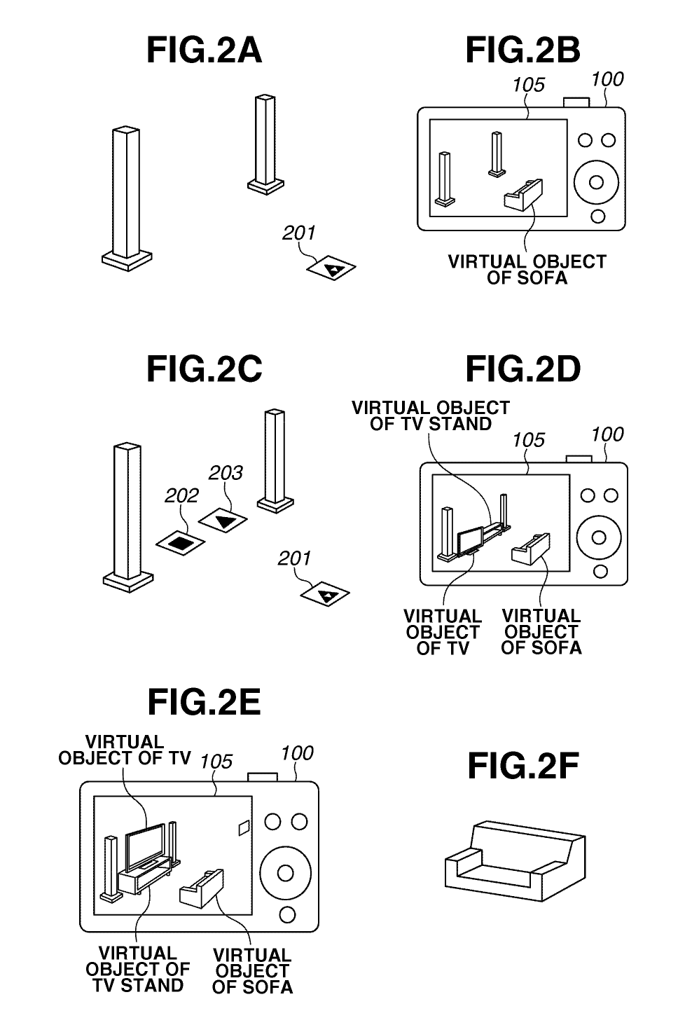

In the present exemplary embodiment, an augmented reality space is achieved by using the above-described digital camera 100. FIG. 2 illustrates an example use of the digital camera 100 when producing an augmented reality space and an example of an augmented reality space to be displayed on the display unit 105.

FIG. 2A illustrates an example where a marker is arranged in the real space. This example illustrates a state where the user attempts to simulate arranging of a sofa in his or her room. In the room, there is one set of speakers and a marker 201 is arranged at a position facing the speakers. A marker according to the present exemplary embodiment, for example, is identification information corresponding to a predetermined virtual object, represented by a two-dimensional code of a specific pattern. Hereinafter, representing information with a two-dimensional code of a specific pattern is referred to as two-dimensionally coding the information.

Paper on which markers are printed is also referred to as a marker. Via pattern recognition, the control unit 101 according to the present exemplary embodiment reads the identification information two-dimensionally coded with a specific pattern indicated by the marker. A marker has a pattern for detection (hereinafter referred to as a detection pattern) arranged therein. The control unit 101 reads the detection pattern via pattern recognition to recognize the existence of the marker. The detection pattern is two-dimensionally coded, for example, by printing a specific pattern on the four corners of the marker.

The control unit 101 detects a marker via pattern recognition and, based on the result of marker detection, geometrically calculates position information indicating the marker's three-dimensional position with respect to the position of the digital camera 100 and posture information indicating the marker's posture. The control unit 101 reads from the recording medium 107 a virtual object corresponding to the read identification information.

Then, the control unit 101 superimposes and displays the read virtual object on the through image to produce an augmented reality space using virtual objects corresponding to markers. The marker 201 is two-dimensionally coded identification information associated with a sofa's virtual object. Hereinafter, the identification information corresponding to a virtual object to be displayed by arranging a certain marker is also referred to as corresponding identification information for the marker.

FIG. 2B illustrates an example display of the display unit 105 when the user shoots an image of the room (see FIG. 2A) and displays the through image by using the digital camera 100. FIG. 2B illustrates a state where the sofa's virtual object corresponding to the marker 201 is displayed on the through image based on the arrangement position and posture of the marker 201. When displaying the virtual object, the control unit 101 applies image processing to the virtual object recorded in the recording medium 107 based on the position information and the posture information. The position information indicates the marker's three-dimensional position and the posture information indicates the marker's posture. Thus, a virtual object suitable for marker's position and posture is displayed. The image processing refers to enlargement, reduction, and rotation.

For example, the sofa's virtual object as illustrated in FIG. 2F is associated with the correspondence identification information for the marker 201 (see FIG. 2A). The sofa's virtual object is recorded in the recording medium 107. With virtual objects recorded in the recording medium 107, initial values of size and posture are predetermined. In the image processing, the control unit 101 performs enlargement, reduction, and rotation according to the marker's position and posture based on the predetermined initial values of size and posture.

Thus, as illustrated in FIG. 2B, for example, the sofa's virtual object (see FIG. 2F) is processed into a size and posture suitable for the arrangement position and posture of the marker 201 and then displayed at a position on the through image suitable for the marker 201 to be arranged. In this example, the marker 201 is arranged at a position facing the speakers, and the sofa's virtual object is displayed in size according to the distance from the digital camera 100 to the marker 201. The marker 201 is determined to be oriented toward the speakers. The posture of the sofa's virtual object is also oriented in a direction corresponding to the posture of the marker 201. Known methods can be used to apply image processing to these virtual objects. Procedures for displaying virtual objects will be described in detail below.

As described above, by arranging a marker in the real space, shooting the marker, and displaying it on the through image, the user can simulate arranging of the sofa in the room in the augmented reality space.

FIG. 2C illustrates an example where two additional markers are arranged in the room illustrated in the example in FIG. 2A. In this example, the user attempts to simulate arranging of a TV stand and arranging of a TV on the TV stand. In this example, markers 202 and 203 are arranged side by side between the speakers, in addition to the marker 201. The marker 202 is two-dimensionally coded identification information associated with a TV's virtual object. The marker 203 is two-dimensionally coded identification information associated with a TV stand's virtual object.

In a conventional apparatus producing an augmented reality space, when the markers 202 and 203 are arranged side by side in this way, virtual objects indicated by respective markers are also arranged side by side based on the positions of respective markers, as illustrated in FIG. 2D. Meanwhile, suppose an augmented reality space is produced in a state where the TV is arranged on the TV stand, as illustrated in FIG. 2E, for example, it is conventionally necessary to capture an image while holding the marker of the TV by hand in the air. Thus, the conventional method is inconvenient because of unstable display position and the need of user's effort. When displaying a specific combination of virtual objects such as those of the TV and the TV stand, it is difficult to produce an augmented reality space by using the conventional method for achieving augmented reality because of the above-described problems.

Therefore, the digital camera 100 according to the present exemplary embodiment displays a plurality of virtual objects on the through image in a suitable arrangement, based on the correspondence identification information, related identification information, and arrangement information included in markers. The related identification information and the arrangement information will be described below.

In the present exemplary embodiment, a marker is two-dimensionally coded so as to include not only the correspondence identification information but also the related identification information. The related identification information refers to identification information corresponding to virtual objects desirable to be displayed in a specific arrangement other than a virtual object corresponding to the correspondence identification information for the marker. In the following descriptions, other virtual objects desirable to be displayed in a specific arrangement relative to the virtual object corresponding to the correspondence identification information included in the marker are also referred to as related virtual objects.

The marker also includes the arrangement information. The arrangement information refers to information indicating a positional relation of the related virtual object to the virtual object corresponding to the identification information included in the marker. The arrangement information includes information about display position and display direction of the related virtual object with respect to the virtual object corresponding to the marker's identification information.

The display position information indicates a relative position of the gravity center of the related virtual object with respect to the gravity center of the virtual object corresponding to the correspondence identification information. The display direction information indicates a relative display direction of the related virtual object with respect to the display direction of the virtual object corresponding to the identification information included in the marker. The arrangement information corresponds to the related identification information on a one-to-one basis. In addition, the arrangement of the virtual objects realized by the arrangement information is feasible on reality space.

With such marker configurations, the digital camera 100 according to the present exemplary embodiment is configured in the following way. If a certain marker is detected together with other markers having the correspondence identification information which is the same identification information as the related identification information included in the former marker, the digital camera 100 displays virtual objects corresponding to respective markers in a specific arrangement based on the arrangement information.

Referring to the example of the TV and TV stand, the marker 203 for the TV stand includes not only the correspondence identification information indicating the TV stand's virtual object but also two pieces of two-dimensionally coded information. One is two-dimensionally coded identification information as related identification information indicating the TV's virtual object (marker 202) desirable to be displayed in a specific arrangement in combination with the TV stand. The other is two-dimensionally coded arrangement information indicating how the TV's virtual object is to be arranged with respect to the TV stand's virtual object. In this example, the markers 202 and 201 include neither the related identification information nor the arrangement information.

When the markers 202 and 203 are arranged side by side as illustrated in FIG. 2C, virtual objects of respective markers are determined desirable to be displayed in a specific arrangement based on the related identification information obtained from the marker 203 and the correspondence identification information obtained from the marker 202. The virtual objects of respective markers are displayed as illustrated in FIG. 2E based not only on the position information and posture information acquired via pattern recognition but also on the arrangement information. In this case, based on the center-of-gravity position of the TV stand's virtual object for the marker 203, the TV's virtual object for the marker 202 is processed based on the position and orientation indicated by the arrangement information included in the marker 201. In other words, the position information and posture information for the marker 202 are not used. In the following descriptions, a virtual object which serves as a base when displayed together with virtual objects of other markers, like the TV stand's virtual object for the marker 203, is referred to as a base virtual object in contrast to the related virtual object.

In the present exemplary embodiment, by introducing the related identification information and the arrangement information as described above, a specific combination of virtual objects can be displayed in a suitable arrangement.

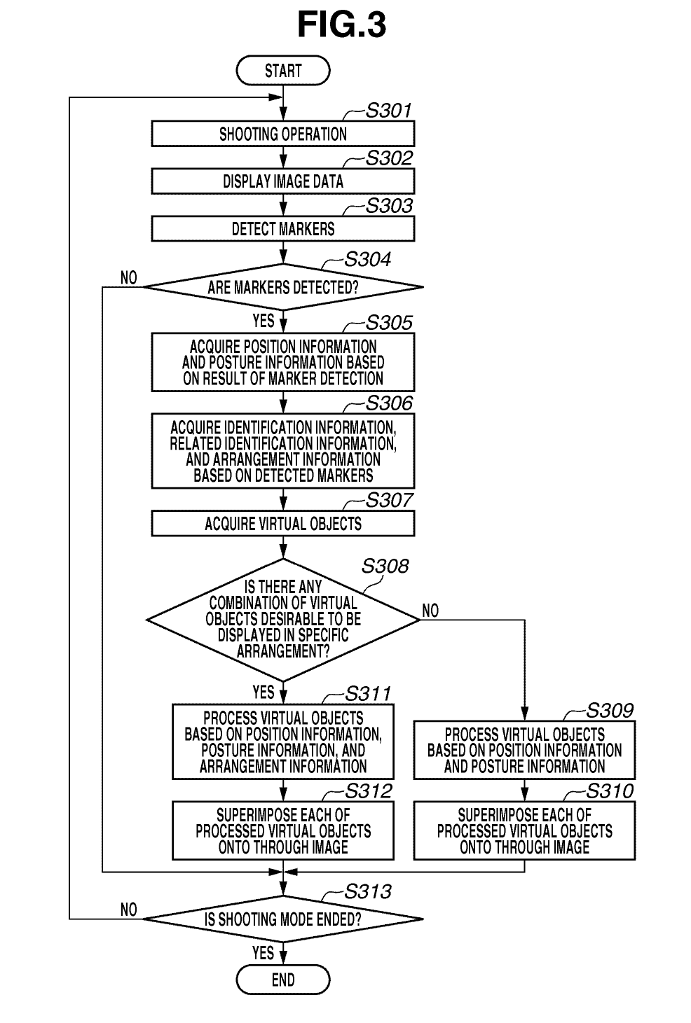

Processing for achieving augmented reality according to the present exemplary embodiment will be described below with reference to FIG. 3. FIG. 3 is a flowchart illustrating operations performed by the digital camera 100 to achieve augmented reality. Each step in this flowchart is implemented when the control unit 101 loads a relevant program stored in the nonvolatile memory 103 into the working memory 104 and then controls each unit of the digital camera 100 according to the program.

Processing illustrated in this flowchart is started when the digital camera 100 enters the shooting mode.

In step S301, the control unit 101 performs the shooting operation via the image pickup unit 102 to acquire image data.

In step S302, the control unit 101 displays the image data acquired in step S301 on the display unit 105 as a through image.

In step S303, the control unit 101 performs processing for detecting one or a plurality of markers from the through image. Specifically, the control unit 101 detects via pattern recognition the detection patterns printed on a marker from the through image.

In step S304, the control unit 101 determines whether markers have been detected in step S303. When the control unit 101 determines that markers have not been detected (NO in step S304), the processing proceeds to step S313. On the other hand, when the control unit 101 determines that markers have been detected in step S303 (YES in step S304), the processing proceeds to step S305.

In step S305, based on the result of pattern recognition, the control unit 101 calculates position information (indicating the three-dimensional position of respective markers) and posture information (indicating the posture of respective markers) for each of the one or more markers detected in step 303.

In step S306, the control unit 101 acquires the correspondence identification information, related identification information, and arrangement information two-dimensionally coded in each marker from the one or more markers detected in step 303.

In step S307, the control unit 101 acquires virtual objects corresponding to respective correspondence identification information acquired from the one or more markers in step S306. Specifically, the control unit 101 reads virtual objects corresponding to the correspondence identification information based on the virtual object table recorded in the recording medium 107 and the correspondence identification information acquired in step S306.

In step S308, the control unit 101 determines whether there is any combination of two or more virtual objects desirable to be displayed in a specific arrangement, out of the virtual objects acquired in step S307. Specifically, the control unit 101 determines whether the related identification information acquired from a certain marker in step S306 is identical to the correspondence identification information acquired from other markers in the same step. As described above, the related identification information refers to information indicating the correspondence identification information for other virtual objects desirable to be displayed in a specific arrangement in combination with the virtual objects corresponding to the markers containing the related identification information. Specifically, when the related identification information for a certain marker is identical to the correspondence identification information for other markers, the control unit 101 determines it desirable to display a combination of the virtual object of the former maker and the virtual objects of the latter markers (other markers) in a specific arrangement.

In other words, when the related identification information for a certain marker is identical to the correspondence identification information for other markers, the virtual object of the former maker and the virtual objects of the latter markers (other markers) have a relation of a base virtual object and related virtual objects related thereto.

On the other hand, when the related identification information for a certain marker is not identical to the correspondence identification information for other markers, the control unit 101 determines it unnecessary to display a combination of the virtual object of the former maker and the virtual objects of the latter markers (other markers) in a specific arrangement.

When the control unit 101 determines that there is no combination of two or more virtual objects desirable to be displayed in a specific arrangement, in the virtual objects acquired in step S307 (NO in step S308), the processing proceeds to step S309.

In step S309, the control unit 101 processes the virtual objects of respective markers based on the position information and posture information acquired based on the result of pattern recognition of respective markers in step S305.

In step S310, based on the position information of respective markers, the control unit 101 superimposes and displays the virtual objects processed in step S309 on the positions on the through image at which respective markers were detected. In this case, based on the position information of respective markers, the control unit 101 sequentially superimposes and displays the virtual objects of respective markers in order of the depth position of marker from the one arranged in the back to naturally express positional relations between the virtual objects. Then, the processing proceeds to step S313.

In step S313, the control unit 101 determines whether a command for terminating the shooting mode is received. When the control unit 101 determines that the command for terminating the shooting mode is received (YES in step S313), the processing exits this flowchart. On the other hand, when the control unit 101 determines that the command for terminating the shooting mode is not received (NO in step S313), the processing returns to step S301 to repeat the processing of this flowchart. Specifically, in the shooting mode, the through image is refreshed each time this flowchart is repeated. Likewise, display of the virtual objects is refreshed each time this flowchart is repeated.

The above-described processing is executed when the control unit 101 determines (in step S308) that there is no combination of virtual objects desirable to be displayed in a specific arrangement.

When the control unit 101 determines that there is any combination of two or more virtual objects desirable to be displayed in a specific arrangement, out of the virtual objects acquired in step S307 (YES in step S308), the processing proceeds to step S311.

In step S311, the control unit 101 processes the relevant virtual objects. In step S311, the control unit 101 processes related virtual objects, out of the combinational virtual objects determined desirable to be displayed in a specific arrangement, based on the position information, posture information, and arrangement information for the marker of the base virtual object. Specifically, the position information and posture information for markers of related virtual objects are not used. Similar to the virtual objects not determined desirable to be displayed in a specific arrangement, the base virtual object is processed in similar processing to that in step S309.

In step S312, the control unit 101 superimposes and displays the virtual objects processed in step S311 on the through image. In step S312, similar to step S310, the control unit 101 superimposes and displays the virtual objects determined (in step S308) as not required to be displayed in a specific arrangement, on the positions on the through image at which respective markers were detected, based on respective position information. On the other hand, the control unit 101 further superimposes and displays the related virtual object, out of the virtual objects determined (in step S308) desirable to be displayed in a specific arrangement, on the through image in a specific arrangement, based on the position information, posture information, and arrangement information of the base virtual object.

Similar to other virtual objects, the base virtual object is displayed based on the position information and posture information of the corresponding marker. Referring to the example in FIG. 2C, with reference to the position information and posture information for the marker 203 corresponding to the base virtual object, the control unit 101 displays the TV's virtual object (related virtual object) at a position deviated a distance indicated by the arrangement information at an orientation deviated by an amount indicated by the arrangement information.

The above-described processing is executed when the control unit 101 determines (in step S308) that there is any combination of virtual objects desirable to be displayed in a specific arrangement. Then, the processing proceeds to step S313. Subsequent processing is as described above.

Operations performed by the digital camera 100 to produce an augmented reality space according to the present exemplary embodiment have specifically been described above. As described above, according to the present exemplary embodiment, the digital camera 100 can display a specific combination of virtual objects in a suitable arrangement. Thus, as in the above-described example for simulating arranging of the TV and the TV stand in the room, a suitable augmented reality space can be produced even in a case where it is difficult to display virtual objects with an arrangement as intended by the user employing a conventional method for achieving augmented reality.

The digital camera 100 according to the present exemplary embodiment is an example of an image processing apparatus. The present invention is applicable not only to digital cameras but also to other apparatuses such as personal computers (PC) and mobile phones without an image pickup unit. In this case, an image processing apparatus acquires an image in which markers are included, and analyzes and displays the image to produce an augmented reality space.

In the first exemplary embodiment, the digital camera 100 performs processing for acquiring virtual objects. In this case, the digital camera 100 stores a virtual object table and virtual objects in a recording medium. Specifically, to produce an augmented reality space by using a new virtual object not recorded in the recording medium, it is necessary to add from outside to the recording medium the new virtual object and the identification information associated with the new virtual object. For example, suppose new furniture described in the first exemplary embodiment is introduced into a market. In this case, to produce an augmented reality space by using the new furniture, it is necessary for the user of the digital camera 100 to add to the recording medium a virtual object corresponding to the new furniture and identification information associated with the virtual object. This operation is inconvenient for the user since it is required each time new furniture is introduced.

In a second exemplary embodiment, therefore, a server executes the processing for reading virtual objects corresponding to the identification information and the image processing applied to the virtual objects which have been executed by the digital camera 100. With this augmented reality system, the server prestores a virtual object table and virtual objects. Upon reception of identification information from the digital camera 100, the server transmits virtual objects based on the received identification information to the digital camera 100. Then, the digital camera 100 produces an augmented reality space by using the virtual objects received from the server.

When the apparatus having virtual objects and the virtual object table from the apparatus producing an augmented reality space are separated in this way, a configuration can be easily realized in which a service provider manages the server and the user utilizes services based on a digital camera. Specifically, since the service provider adds new virtual objects and relevant identification information as required at any time, the user can constantly utilize services based on latest virtual objects without burden. Referring to the example of furniture according to the first exemplary embodiment, when new furniture is introduced into a market, an administrator prepares a virtual object of the new furniture and corresponding identification information at any time, enabling the user to receive without burden augmented reality services using the latest furniture.

The present exemplary embodiment has many portions in common with the first exemplary embodiment, and therefore redundant descriptions of common portions will be avoided. Descriptions will be made centering on portions specific to the present exemplary embodiment.

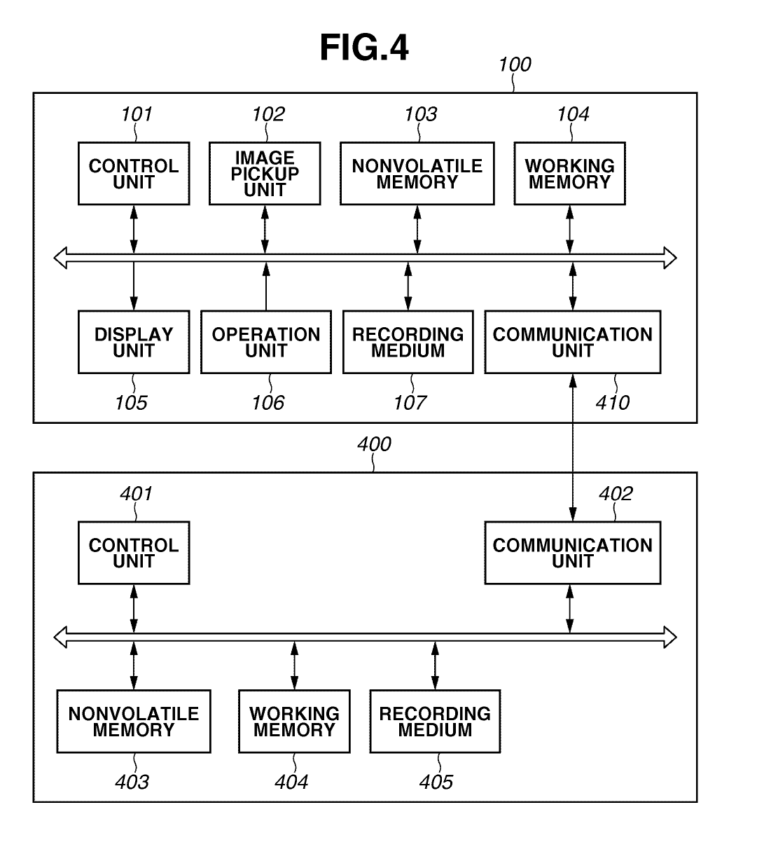

A digital camera (an example of an image processing apparatus) for achieving augmented reality and a server (an example of an information processing apparatus) for achieving augmented reality according to the present exemplary embodiment will be described below with reference to FIG. 4. The digital camera and the server operate in collaboration with each other. FIG. 4 is a block diagram illustrating the digital camera 100 and a server 400. Elements equivalent to those in the first exemplary embodiment are assigned the same reference numerals.

Referring to FIG. 4, the digital camera 100 includes a communication unit 410 which is a connection unit for communicating with an external apparatus. The communication unit 410 is used to transmit to the server 400 the correspondence identification information, related identification information, and arrangement information acquired from markers captured by the digital camera 100. The communication unit 410 is also used to transmit to the server 400 the position information and posture information acquired based on the result of pattern recognition of the markers. The communication unit 410 is also used to receive virtual objects from the server 400. The communication unit 410 may perform wired or wireless communication with the server 400.

In the server 400 illustrated in FIG. 4, a control unit 401 controls each unit of the server 400 according to an input signal and a program (described below). The server 400 may be controlled by one piece of hardware or a plurality of pieces of hardware in charge of different processing.

The communication unit 402 is used to receive various information from the digital camera 100. The communication unit 402 is also used to transmit to the digital camera 100 virtual objects corresponding to the information received from the digital camera 100.

A nonvolatile memory 403 stores a program (firmware) for controlling each unit of the server 400 and various setting information. The nonvolatile memory 403 also stores a program executed by the control unit 401 to control the processing of each flowchart (described below).

A working memory 404 is a memory into which the program stored in the nonvolatile memory 403 is loaded. The working memory 404 is used as a working area for the control unit 401.

A recording medium 405 records virtual objects and identification information indicating the virtual objects in an associated way for achieving augmented reality. This information is stored in table form, for example, as a virtual object table. Virtual objects according to the present exemplary embodiment include, for example, three-dimensional image models of furniture and household appliances. The recording medium 405 records also these three-dimensional image models. By checking the identification information transmitted from the digital camera 100 in the virtual object table, the server 400 according to the present exemplary embodiment acquires virtual objects indicated by the identification information.

The server 400 transmits the acquired virtual object to the digital camera 100 via the communication unit 402, and the digital camera 100 produces an augmented reality space by using the virtual object. The recording medium 405 may be detachably attached to, or included in the server 400. Specifically, the server 400 needs to be provided with at least a method for accessing the recording medium 405.

The configuration of the digital camera 100 according to the present exemplary embodiment has specifically been described above.

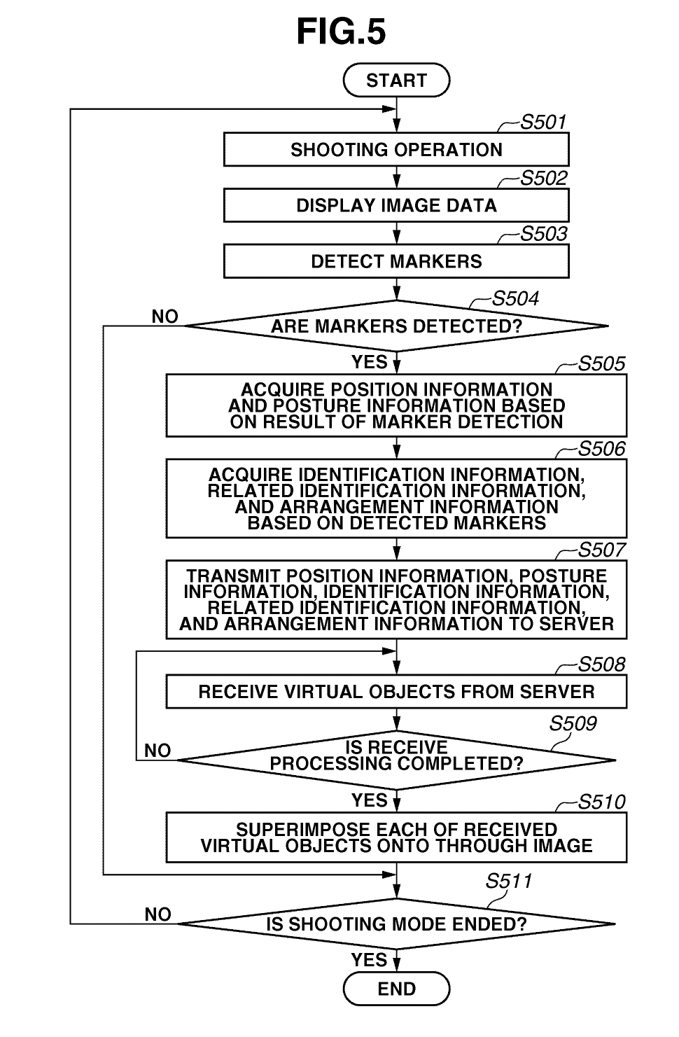

Operations performed by the digital camera 100 to achieve augmented reality will be described below with reference to FIG. 5.

FIG. 5 is a flowchart illustrating operations performed by the digital camera 100 to produce an augmented reality space. Each step in this flowchart is implemented when the control unit 101 loads a relevant program stored in the nonvolatile memory 103 into the working memory 104 and then controls each unit of the digital camera 100 according to the program.

Processing illustrated in this flowchart is started when the digital camera 100 enters the shooting mode.

In steps S501 to S506, the digital camera 100 executes processing similar to steps S301 to S306 (see FIG. 3), respectively.

In step S507, the control unit 101 transmits to the server 400 the position information and posture information acquired in step S505 and the correspondence identification information, related identification information, and arrangement information acquired in step S506. Each piece of information is transmitted in a distinguishable way for each marker detected in step S503.

In step S508, the control unit 101 receives virtual objects transmitted from the server 400. The received virtual objects are processed virtual objects corresponding to the identification information transmitted from the digital camera 100 to the server 400 in step S507. The image processing is executed by the server 400 based on the position information, posture information, related identification information, and arrangement information transmitted from the digital camera 100 to the server 400 in step S507. Virtual objects determined desirable to be displayed in a specific arrangement and other virtual objects are received in a distinguishable way.

In step S509, the control unit 101 determines whether the receive processing in step S508 is completed. Specifically, the control unit 101 determines whether all of the processed virtual objects corresponding to each of identification information transmitted from the digital camera 100 to the server 400 in step S507 have been received. When the control unit 101 does not determine that all of the virtual objects have been received (NO in step S509), the processing returns to step S508 to wait for completion of the receive processing. On the other hand, when the control unit 101 determines that all of the virtual objects have been received (YES in step S509), the processing proceeds to step S510.

In step S510, based on the position information and arrangement information acquired in step S505, the control unit 101 superimposes and displays on the through image the virtual objects determined desirable to be displayed in a specific arrangement received from the server 400. Further, based on the position information acquired in step S505, the control unit 101 superimposes and displays on the through image the virtual objects determined unnecessary to be displayed in a specific arrangement received from the server 400.

Then, the processing proceeds to step S511. In step S511, the control unit 101 executes processing similar to step S313 (see FIG. 3).

Operations performed by the digital camera 100 to achieve augmented reality in collaboration with the server 400 have specifically been described above.

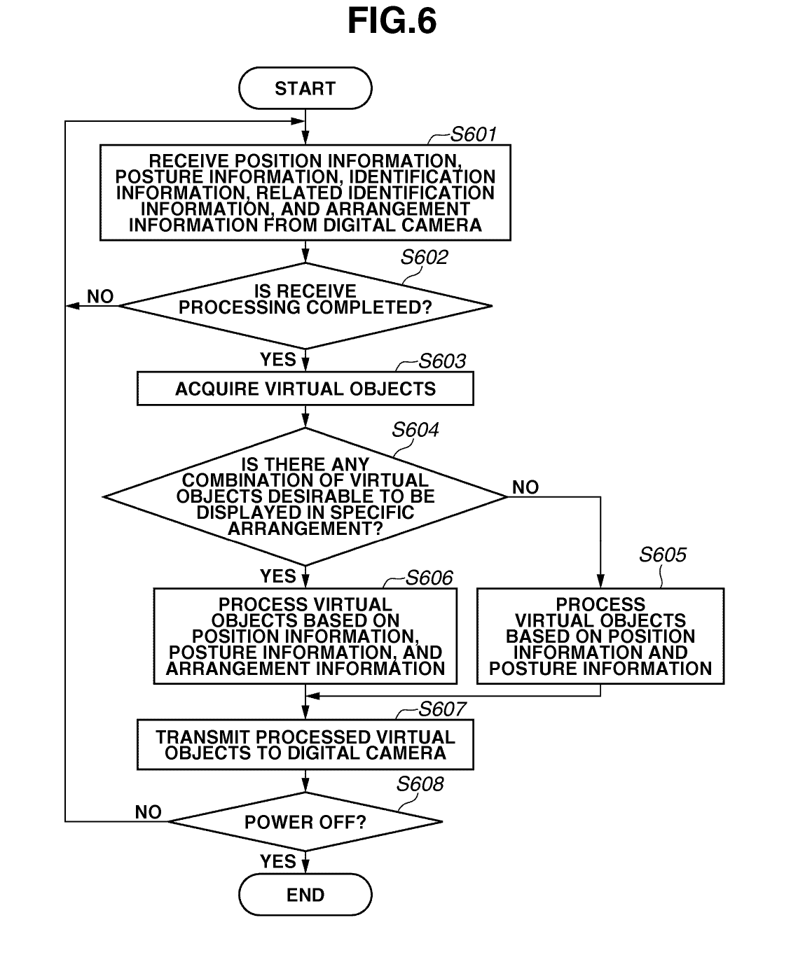

Operations performed by the server 400 to produce an augmented reality space in collaboration with the above-described digital camera 100 will be described below with reference to FIG. 6. FIG. 6 is a flowchart illustrating operations performed by the server 400 to produce an augmented reality space in collaboration with the digital camera 100. Each step in this flowchart is implemented when the control unit 401 loads a relevant program stored in the nonvolatile memory 403 into the working memory 404 and then controls each unit of the server 400 according to the program.

Processing illustrated in this flowchart is started when the power of the server 400 is turned ON.

In step S601, the control unit 401 receives the correspondence identification information, related identification information, arrangement information, position information, and posture information obtained from one or more markers detected by the digital camera 100. Each piece of information is received such that each of information acquired from a certain marker is distinguishable from each of information acquired from other markers.

In step S602, the control unit 401 determines whether the correspondence identification information, related identification information, arrangement information, position information, and posture information have been received for all of the markers detected by the digital camera 100. When the control unit 401 determines that the above-described information has not been received (NO in step S602), the processing returns to step S601 to wait for reception of the above-described information from the digital camera 100. On the other hand, when the control unit 401 determines that the above-described information has been received (YES in step S602), the processing proceeds to step S603.

In step S603, based on the virtual object table recorded in the recording medium 405 and the correspondence identification information received in step S601, the control unit 401 reads virtual objects corresponding to the correspondence identification information from the recording medium 405.

In step S604 to S606, the server 400 performs processing similar to steps S308, S309, and S311 (see FIG. 3), respectively. When the image processing applied to the virtual objects is completed in step S605 or S606, the processing proceeds to step S607.

In step S607, the control unit 401 transmits the virtual objects processed in step S605 or S606 to the digital camera 100 via the communication unit 402. In this case, the virtual objects determined desirable to be displayed in a specific arrangement and other virtual objects are transmitted in a distinguishable way.

In step S608, the control unit 401 determines whether a command for terminating this flowchart has been received. When the control unit 401 determines that the command for terminating this flowchart has been received (YES in step S608), the processing exits this flowchart. When the control unit 401 determines that the command for terminating this flowchart has not been received (NO in step S608), the processing returns to step S601 to repeat processing of this flowchart.

Operations performed by the server 400 to achieve augmented reality in collaboration with the digital camera 100 have specifically been described above.

As described above, in the present exemplary embodiment, virtual objects are stored in the server 400. In this way, it becomes easy to differentiate the administrator who manages virtual objects and identification information from the user of the digital camera 100. Specifically, for example, the service provider manages the server 400 and the user utilizes services based on the digital camera 100. As a result, since the service provider adds new virtual objects and relevant identification information as required at any time, the user can constantly utilize services based on latest virtual objects without burden. Therefore, by configuring an augmented reality system as in the present exemplary embodiment, services more convenient for the user can be provided.

In the above-described exemplary embodiments, virtual objects corresponding to markers detected by the digital camera 100 are displayed. A third exemplary embodiment allows displaying, in addition to virtual objects corresponding to detected markers, virtual objects frequently displayed together with the virtual objects corresponding to the detected markers. For example, when a TV stand's marker is arranged, not only a TV stand's virtual object but also a TV's virtual object can be displayed without arranging a TV's marker which is frequently arranged together with the TV stand's marker.

The above-described augmented reality system according to the present exemplary embodiment will be described below.

The present exemplary embodiment has many portions in common with the first and second exemplary embodiments, and therefore redundant descriptions of common portions will be avoided. Descriptions will be made centering on portions specific to the present exemplary embodiment.

The augmented reality system according to the present exemplary embodiment is similar to the system according to the second exemplary embodiment which includes the digital camera 100 and the server 400. A recommended virtual object table for achieving the above-described augmented reality system is recorded in the recording medium 405 of the server 400 according to the present exemplary embodiment. When there is a plurality of digital cameras 100, the recommended virtual object table may be provided for each camera or provided as one common table. The present exemplary embodiment will be described below assuming that this table is provided as one common table.

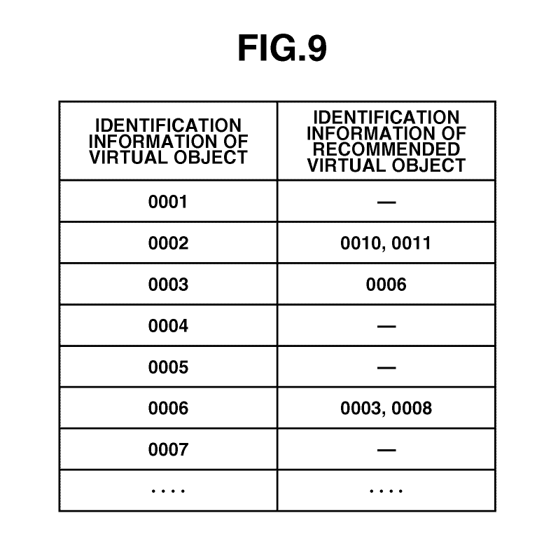

FIG. 9 illustrates a concept of the above-described recommended virtual object table. In the recommended virtual object table, each of identification information recorded in the recording medium 405 is associated with the identification information for other virtual objects different from the virtual object corresponding to certain identification information, as identification information for a recommended virtual object. Thus, a certain virtual object is associated with other virtual objects recommended to be displayed with the virtual object. For example, in the recommended virtual object table illustrated in FIG. 9, a virtual object having identification information 0003 is associated with a virtual object having identification information 0006 as a recommended virtual object.

The identification information for the recommended virtual object is the identification information for the virtual object determined to be frequently displayed on the same screen together with the virtual object of the associated identification information. For example, in the recommended virtual object table illustrated in FIG. 9, the virtual object having identification information 0003 is determined to be frequently displayed together with the virtual object having identification information 0006. The frequency at which a virtual object is displayed together with other virtual objects is determined by recording the number of times each of other identification information is received together, for each of identification information received from the digital camera 100.

Specifically, when the server 400 receives a plurality of pieces of identification information from the digital camera 100, the server 400 records the number of times each of other identification information is received together, for each of identification information received from the digital camera 100. Thus, the server 400 counts the frequency at which a virtual object corresponding to certain identification information and a virtual object corresponding to each of other identification information are displayed together on the same screen.

Then, the identification information received together the largest number of times is associated as identification information indicating a recommended virtual object, for each of identification information. Thus, other virtual objects displayed on the same screen together with a virtual object corresponding to certain identification information the largest number of times are associated as a recommended virtual object, for each of identification information.

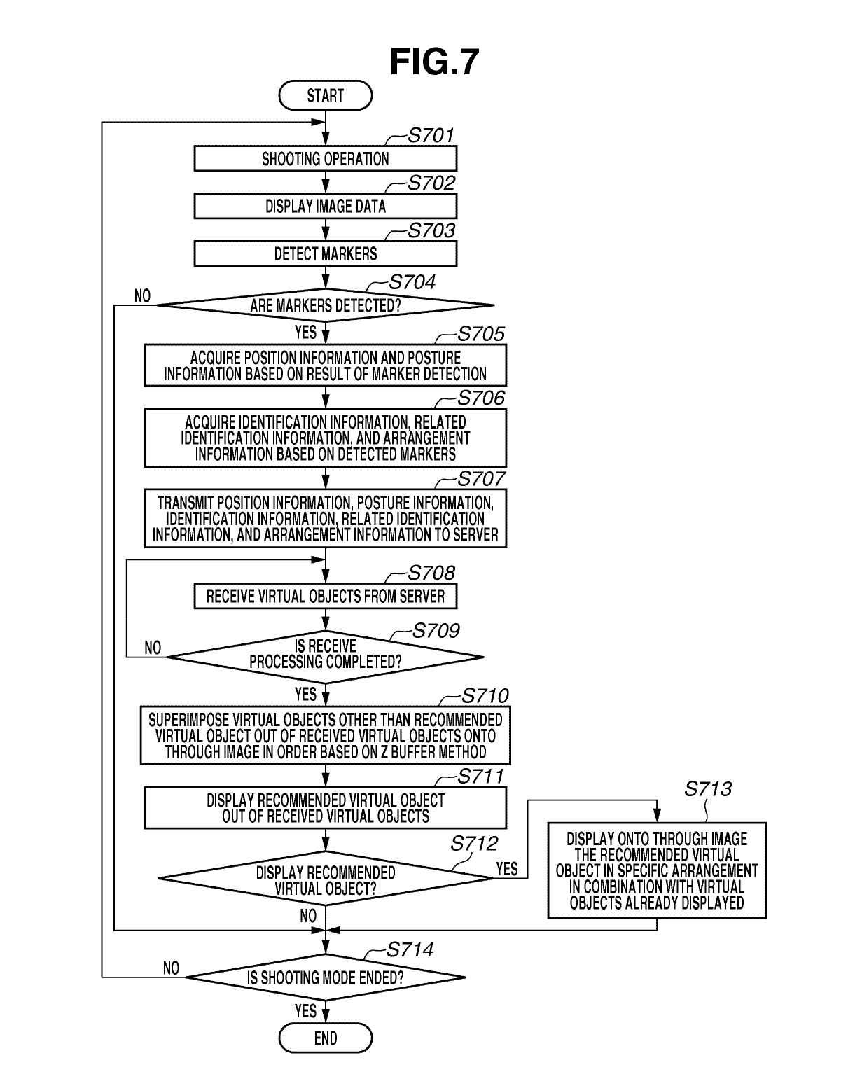

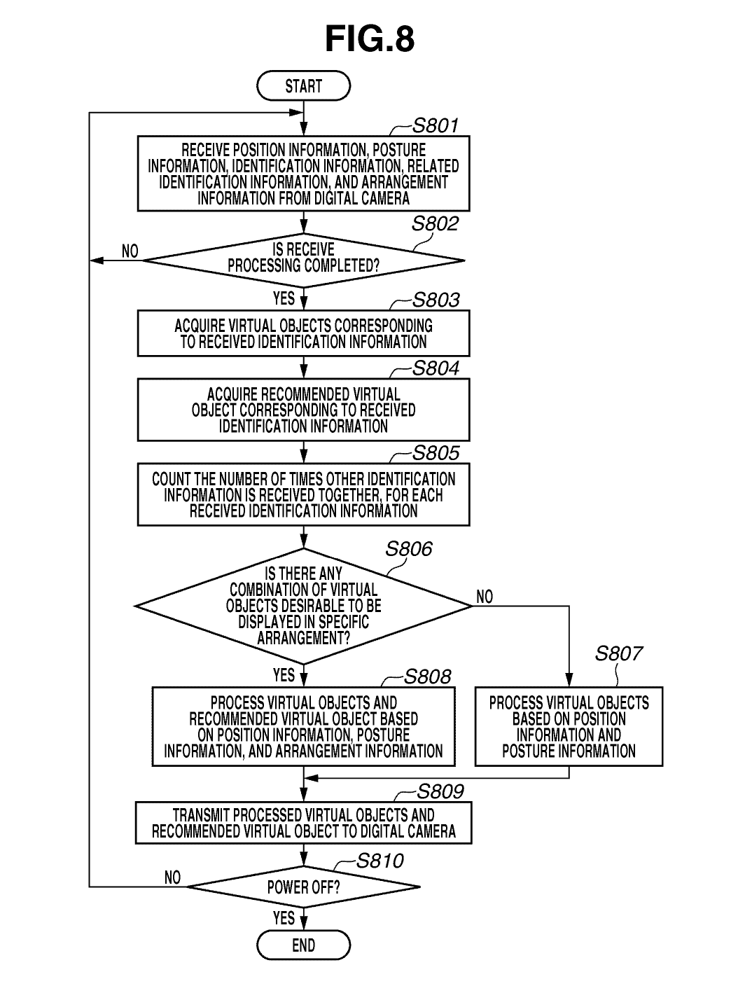

Operations performed by the augmented reality system according to the present exemplary embodiment to achieve augmented reality will be described below with reference to FIGS. 7 and 8. FIG. 7 is a flowchart illustrating operations performed by the digital camera 100 to achieve augmented reality. Each step in this flowchart is implemented when the control unit 101 loads a relevant program stored in the nonvolatile memory 103 into the working memory 104 and then controls each unit of the digital camera 100 according to the program.

Processing illustrated in this flowchart is started when the digital camera 100 enters the shooting mode.

In steps S701 to S709, the control unit 101 executes processing similar to steps S501 to S509 (see FIG. 5), respectively.

In step S710, the control unit 101 superimposes and displays virtual objects other than the recommended virtual object, out of the virtual objects received in step S708, on the through image. This processing is similar to the processing in step S312 (see FIG. 3).

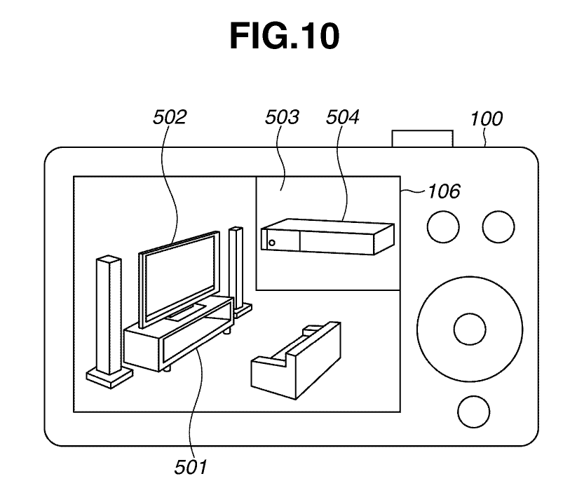

In step S711, the control unit 101 displays the recommended virtual object, out of the virtual objects received in step S708, in a recommended virtual object display area superimposed and displayed on the through image. For example, the recommended virtual object display area is superimposed on the through image, at the upper right position in the display area of the display unit 105, as illustrated in FIG. 10.

In step S712, the control unit 101 receives a command for selecting whether the recommended virtual object displayed in step S711 is to be displayed in the augmented reality space. In parallel, the control unit 101 displays on the display unit 105 a message for prompting the user to select whether the recommended virtual object is to be arranged in the augmented reality space. For example, the control unit 101 displays such a message as “The recommended virtual object can be arranged. Will you arrange it?” together with “YES” and “NO” selectable buttons.

When the user selects “YES” (YES in step S712), the control unit 101 determines that the user selects to arrange the recommended virtual object in the augmented reality space, and the processing proceeds to step S713. When the user selects “NO” (NO in step S712), the control unit 101 determines that the user selects not to arrange the recommended virtual object in the augmented reality space, and the processing proceeds to step S714.

In step S713, the control unit 101 displays in the augmented reality space the recommended virtual object determined (in step S712) to be arranged in the augmented reality space. In the present exemplary embodiment, when a recommended virtual object is a virtual object desirable to be displayed in a specific arrangement in combination with the virtual objects already displayed, the recommended virtual object is displayed in the specific arrangement. Otherwise, the recommended virtual object is displayed at the center of the through image. In this case, the user can freely change afterwards the display position, size, and posture of the recommended virtual object via the operation unit 106.

In step S714, the control unit executes processing similar to step S314 (see FIG. 3).

Operations performed by the digital camera 100 according to the present exemplary embodiment to achieve augmented reality in collaboration with the server 400 have specifically been described above.

Operations performed by the server 400 according to the present exemplary embodiment to produce an augmented reality space in collaboration with the above-described digital camera 100 will be described below with reference to FIG. 8. FIG. 8 is a flowchart illustrating operations performed by the server 400 to produce an augmented reality space in collaboration with the digital camera 100. Each step in this flowchart is implemented when the control unit 401 reads a program stored in the nonvolatile memory 403 into the working memory 404 and then controls each unit of the server 400 according to the program.

Processing illustrated in this flowchart is started when the power of the server 400 is turned ON.

In step S801 to S803, the control unit 401 executes processing similar to step S601 to S603 (see FIG. 6), respectively.

In step S804, the control unit 401 acquires a recommended virtual object for each of the virtual objects acquired in step S603. Specifically, based on the correspondence identification information received in step S801 and the recommended virtual object table recorded in the recording medium 405, the control unit 401 reads from the recording medium 405 a recommended virtual object associated with each of identification information. In step S804, the control unit 401 does not read the virtual objects already read in step S803.

In step S805, when the server 400 receives a plurality of identification information from the digital camera 100 in step S801, the control unit 401 counts the number of times each of other identification information is received together, for each of correspondence identification information. Specifically, the control unit 401 counts for each combination of virtual objects the number of times a marker indicating the correspondence identification information is captured together by the digital cameras 100. As a result of counting, the control unit 401 associates the correspondence identification information determined to be received together the largest number of times as identification information for the recommended virtual object and then records the identification information in the recommended virtual object table, for each of identification information.

In step S806, the control unit 401 determines whether there is any combination of two or more virtual objects desirable to be displayed in a specific arrangement, out of the virtual objects acquired in steps S803 and S804. When the control unit 401 determines that there is no combination of two or more virtual objects desirable to be displayed in a specific arrangement (NO in step S806), the processing proceeds to step S807. In step S807, based on the position information and posture information for each of correspondence identification information received in step S801, the control unit 401 processes virtual objects corresponding to respective correspondence identification information. When all of the virtual objects have been processed, the processing proceeds to step S809.

On the other hand, when the control unit 401 determines that there is any combination of two or more virtual objects desirable to be displayed in a specific arrangement (YES in step S806), the processing proceeds to step S808.

In step S808, the control unit 401 processes the relevant virtual objects. In step S808, the control unit 401 processes the combinational virtual objects determined (in step S806) desirable to be displayed in a specific arrangement, based not only on the position information and posture information of respective markers but also on the arrangement information acquired in step S801. The control unit 401 processes other virtual objects in a way similar to step S807. However, the control unit 401 does not process the recommended virtual object which the control unit 401 determines does not combine with virtual objects desirable to be displayed in a specific arrangement, since there is no corresponding position information or posture information.

When all of virtual objects have been processed, the processing proceeds to step S809.

In step S809, the control unit 401 transmits the virtual objects processed in step S807 or S808 to the digital camera 100 via the communication unit 402. In this case, the combinational virtual objects desirable to be displayed in a specific arrangement and other virtual objects, out of transmitted virtual objects, are transmitted in a distinguishable way. Further, the recommended virtual object and other virtual objects are transmitted in a distinguishable way.

In step S810, the control unit 401 executes processing similar to step S608 (see FIG. 6).

Operations performed by the server 400 to achieve augmented reality in collaboration with the digital camera 100 have specifically been described above.

As described above, in the present exemplary embodiment, not only virtual objects corresponding to markers set by the user but also virtual objects determined to be frequently displayed together with the virtual objects are displayed as a recommended virtual object. This allows producing of an augmented reality space which is more convenient for the user.

In the above-described exemplary embodiments, all of markers captured on the through image are subjected to determination of combination. However, if the user arranges two markers apart from each other, it is highly likely that the user will not display these markers in combination. Accordingly, the present exemplary embodiment determines whether virtual objects are to be displayed in combination according to marker arrangement by the user.

A fourth exemplary embodiment has many portions in common with the first exemplary embodiment, and therefore redundant descriptions of common portions will be avoided. Descriptions will be made centering on portions specific to the present exemplary embodiment.

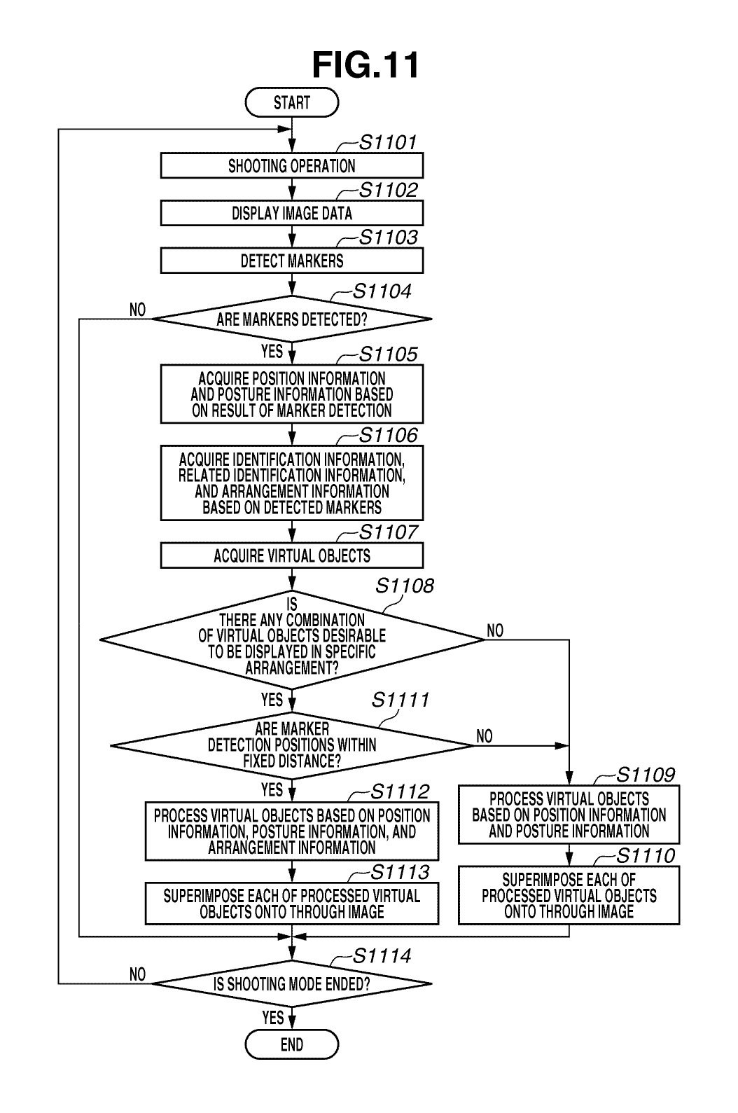

FIG. 11 is a flowchart illustrating operations performed by the digital camera 100 to produce an augmented reality space. Each step in this flowchart is implemented when the control unit 101 loads a relevant program stored in the nonvolatile memory 103 into the working memory 104 and then controls each unit of the digital camera 100 according to the program.

Processing illustrated in this flowchart is started when the digital camera 100 enters the shooting mode.

In step S1101 to S1110, the control unit 101 executes processing similar to steps S301 to S310 (see FIG. 3), respectively.

When the control unit 101 determines that there is any combination of virtual objects desirable to be displayed in a specific arrangement (YES in step S1108), the processing proceeds to step S1111.

In step S1111, the control unit 101 determines whether respective markers corresponding to virtual objects of a combination are detected at positions apart from each other by a fixed distance or less. Specifically, the control unit 101 compares the position information of detected markers to determine whether the positions indicated by the position information are apart from each other by the fixed distance or less. When the control unit 101 determines that markers corresponding to respective virtual objects are not detected at positions apart from each other by the fixed distance or less (NO in step S1111), the processing proceeds to step S1109. Specifically, the control unit 101 does not display virtual objects corresponding to respective markers in a specific arrangement.

On the other hand, when the control unit 101 determines that markers corresponding to respective virtual objects are detected at positions apart from each other by the fixed distance or less (YES in step S1111), the processing proceeds to step S1112. In steps S1112 to S1114, the control unit 101 executes processing similar to steps S311 to S313 (see FIG. 3), respectively. Specifically, virtual objects corresponding to respective markers are displayed in a specific arrangement.

As described above, in the present exemplary embodiment, the control unit 101 uses the position information of detected markers to determine whether a plurality of virtual objects is to be displayed in a specific arrangement. Thus, the user can produce an augmented reality space in a more intuitive way.

### Other Embodiments

In the above-described exemplary embodiments, when a plurality of virtual objects is determined to be a specific combination, each virtual object is constantly displayed in a specific arrangement. However, the user may select whether each virtual object is to be displayed in a specific arrangement. This configuration allows producing of an augmented reality space much more to the user' intent.

In addition to the above-described exemplary embodiments, if displaying each virtual object in a specific arrangement is not sufficient, it is also possible to display specific objects associated with each virtual object. For example, suppose a TV stand and a video recorder are combined. In this case, the user may want to make sure that the video recorder is stored within the TV stand. However, when only arrangement of the objects of the TV stand and video recorder is devised, it is difficult to display a state where the video recorder is stored within the TV stand. Therefore, an object named “TV stand that stores the video recorder” is prepared and, when a combination of the TV stand's marker and the video recorder's marker is detected, the object named “TV stand that stores the video recorder” is displayed. This configuration allows producing of an augmented reality space much more to the user's intent.

In the above-described exemplary embodiments, each combination is determined regardless of marker detection timing. However, if a difference between detection times of the two markers is equal to or larger than a predetermined period of time, it is highly likely that the user will not display virtual objects of these two markers in combination. Therefore, for example, when making a determination about a combination with a certain marker, counting of time is performed for each of detected markers. If other markers are detected after the predetermined period of time has elapsed since the marker was detected, they may not be subjected to determination of combination. Counting the predetermined period of time for each of detected markers may be started when a marker is detected and continue until the predetermined time has elapsed. Alternatively, counting may be terminated when it is determined that markers have not been successively detected. This configuration allows producing of an augmented reality space much more to the user's intent.

In the above-described exemplary embodiments, virtual objects are displayed in a specific arrangement based on the position information for the marker of the base virtual object. In addition to the position information for the marker of the base virtual object, the position information for the marker of the related virtual object may be used. For example, the base and related virtual objects may be displayed between the position indicated by the position information for the marker of the base virtual object and the position indicated by the position information for the marker of the related virtual object. In this case, the base and related virtual objects may be displayed in the middle of the position indicated by the position information for the marker of the base virtual object and the position indicated by the position information for the marker of the related virtual object, or may be displayed at a position deviated toward either of the two positions according to a predetermined criterion.

In the above-described fourth exemplary embodiments, marker detection positions are used to determine a combination, however, the processing is not limited thereto. For example, the posture information of detected markers may be used. For example, if markers are not arranged in the same direction, corresponding virtual objects are not displayed in a specific arrangement. Alternatively, when determining a combination, the posture information may be used in addition to the position information of markers. For example, if makers are adjacently arranged and facing each other, corresponding virtual objects may be displayed in a specific arrangement. Alternatively, if makers are adjacently arranged and oriented in opposite directions, corresponding virtual objects may be displayed in a specific arrangement. This configuration allows more flexibility in producing an augmented reality space.

Each marker may be provided with one or a plurality of pieces of related identification information. If a marker having a plurality of pieces of related identification information is detected together with a marker having the correspondence identification information which is the same identification information as the respective related identification information, there exists a plurality of related virtual objects desirable to be displayed in a specific arrangement. In this case, there may be provided a method for receiving a command to select virtual objects, out of the plurality of related virtual objects, to be displayed in a combination. This is an example of a method for receiving a command. When the user selects to display a specific combination of virtual objects, related virtual objects of other unselected combinations may not be displayed.

Even after virtual objects are displayed on the through image, display positions, sizes, and postures of the virtual objects displayed on the through image may be freely changed according to a user command. In this case, the amount of change is held in each identification information of changed virtual objects and, each time the relevant virtual object is displayed, the amount of change which is being held is reflected and displayed on the through image. This configuration allows producing of an augmented reality space much more to the user's intent.

The present invention is achieved also by performing the following processing. Software (program) for achieving the functions of the above-described exemplary embodiments is supplied to a system or apparatus via a network or various storage media, and a computer (or a central processing unit (CPU) or a microprocessor unit (MPU)) of the system or apparatus reads the program and executes it.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium). In an example, a computer-readable storage medium may store a program that causes an image processing apparatus to perform a method described herein. In another example, a central processing unit (CPU) may be configured to control at least one unit utilized in a method or apparatus described herein.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-234203 filed Oct. 25, 2011, which is hereby incorporated by reference herein in its entirety.

What is claimed is:

1. An image processing apparatus comprising:
an acquisition unit configured to acquire information about a plurality of markers included in an image;
a display control unit configured to perform control to superimpose on the image and display on a display unit a plurality of virtual objects corresponding to the plurality of markers; and
a determination unit configured to determine whether the plurality of virtual objects is a specific combination,
wherein, in response to the determination unit determining that the plurality of virtual objects is a specific combination, the display control unit performs control to superimpose on the image the plurality of virtual objects in a specific arrangement corresponding to the specific combination.

2. The image processing apparatus according to claim 1, wherein the specific arrangement is a feasible arrangement.

3. The image processing apparatus according to claim 1, wherein, in response to the determination unit determining that the plurality of virtual objects is a specific combination, the display control unit performs control to superimpose and display on the image the plurality of virtual objects in the specific arrangement based on positions of the corresponding markers on the image.

4. The image processing apparatus according to claim 1, wherein, in response to the determination unit determining that the plurality of virtual objects is a specific combination, the display control unit performs control to superimpose and display on the image the plurality of virtual objects in the specific arrangement based on at least any one of positions of the corresponding markers on the image.

5. The image processing apparatus according to claim 1, wherein, in response to the determination unit determining that the plurality of virtual objects is a specific combination, the display control unit performs control to superimpose and display on the image the plurality of virtual objects in the specific arrangement between positions of the corresponding markers on the image.

6. The image processing apparatus according to claim 1, wherein, in response to the determination unit determining that the plurality of virtual objects is not a specific combination, the display control unit performs control to superimpose and display on the image the plurality of virtual objects in an arrangement different from the specific arrangement based on positions of the corresponding markers on the image.

7. The image processing apparatus according to claim 1, wherein the plurality of markers include combination information indicating a combinational relation between virtual objects of the plurality of markers and virtual objects of other markers, and
wherein, based on the combination information, the determination unit determines whether the plurality of virtual objects corresponding to the plurality of markers is a specific combination.

8. The image processing apparatus according to claim 7, wherein, in response to the determination unit determining that a virtual object common to a plurality of specific combinations is included in the virtual objects, the display control unit displays any one combination of virtual objects, out of the plurality of combinations, in the specific arrangement.

9. The image processing apparatus according to claim 8, further comprising:
a receiving unit configured to receive a command for selecting any one combination out of the plurality of specific combinations,
wherein the display control unit displays in the specific arrangement a specific combination of visual objects selected by the command received by the receiving unit.

10. The image processing apparatus according to claim 9, wherein virtual objects included in combinations not selected by the command received by the receiving unit are not displayed other than the virtual object common to the plurality of specific combinations.

11. The image processing apparatus according to claim 1, wherein, via the display control unit, a user can select whether the plurality of virtual objects is to be displayed in the specific arrangement.

12. The image processing apparatus according to claim 1, further comprising:
an arrangement determination unit configured to, based on positions of the plurality of markers on the image, determine whether the plurality of virtual objects is to be displayed in the specific arrangement.

13. The image processing apparatus according to claim 1, wherein, in response to a distance between the plurality of markers being equal to or larger than a predetermined value, the display control unit performs control not to display the plurality of virtual objects in the specific arrangement, even if the plurality of virtual objects corresponding to the plurality of markers is a specific combination.

14. The image processing apparatus according to claim 1, wherein, in response to postures of the plurality of markers not being oriented in same direction, the display control unit performs control not to display the plurality of virtual objects in the specific arrangement, even if the plurality of virtual objects corresponding to the plurality of markers is a specific combination.

15. The image processing apparatus according to claim 1, wherein, in response to the plurality of markers both not being adjacently arranged and not facing each other, the display control unit performs control not to display the plurality of virtual objects in the specific arrangement, even if the plurality of virtual objects corresponding to the plurality of markers is a specific combination.

16. The image processing apparatus according to claim 1, wherein, in response to the plurality of markers not being adjacently arranged and oriented in opposite directions, the display control unit performs control not to display the plurality of virtual objects in the specific arrangement, even if the plurality of virtual objects corresponding to the plurality of markers is a specific combination.

17. The image processing apparatus according to claim 1, wherein the specific arrangement refers to an arrangement indicating a positional relation different from the on-image positional relation between the plurality of markers corresponding to the plurality of virtual objects determined to be a specific combination by the determination unit.

18. The image processing apparatus according to claim 1, wherein the plurality of markers include arrangement information indicating a positional relation between virtual objects corresponding to the plurality of markers and other virtual objects having a combinational relation with the virtual objects, and
wherein the display control unit displays, based on the arrangement information, the virtual objects corresponding to the plurality of markers and other virtual objects having a combinational relation with the virtual objects.

19. The image processing apparatus according to claim 18, wherein the arrangement information includes information defining an orientation of other virtual objects having a combinational relation with the virtual object corresponding to the marker, relative to the virtual object.

20. The image processing apparatus according to claim 18, wherein, in response to performing control to display the plurality of virtual objects corresponding to the plurality of markers in the specific arrangement, the display control unit performs control to display the virtual objects in an arrangement based on the on-image positions of the plurality of markers having the arrangement information, out of the on-image positions of the plurality of markers.

21. The image processing apparatus according to claim 1, further comprising:
a detection unit configured to detect the plurality of markers from the image.

22. The image processing apparatus according to claim 21, wherein, in response to the detection unit detecting the plurality of markers, the on-image positions of the plurality of markers are determined.

23. The image processing apparatus according to claim 21, further comprising:
a determination unit configured to determine whether the plurality of virtual objects are to be displayed in the specific arrangement, based on detection time of the plurality of markers detected by the detection unit.

24. The image processing apparatus according to claim 21, wherein, in response to a difference between detection time of the plurality of markers detected by the detection unit being equal to or larger than a predetermined period of time, the display control unit performs control not to display the virtual objects corresponding to the markers in the specific arrangement.

25. The image processing apparatus according to claim 21, further comprising:
an acquisition unit configured to acquire identification information indicated by the plurality of markers detected by the detection unit;
a transmission unit configured to transmit the identification information to an external apparatus; and
a receiving unit configured to receive virtual objects corresponding to the identification information from the external apparatus.

26. The image processing apparatus according to claim 1, further comprising:
a storage unit configured to store the plurality of virtual objects.

27. The image processing apparatus according to claim 26, wherein the storage unit stores a relation between the plurality of virtual objects and the plurality of markers.

28. The image processing apparatus according to claim 1, wherein, according to a user command, the display control unit changes display of the plurality of virtual objects superimposed and displayed on the image.

29. An information processing apparatus capable of communicating with an image processing apparatus, the information processing apparatus comprising:
a receiving unit configured to receive information about a plurality of markers included in an image from the image processing apparatus;
a storage unit configured to store virtual objects corresponding to the plurality of markers;
a determination unit configured to determine whether the plurality of virtual objects corresponding to the plurality of markers is a specific combination;
a processing unit configured to process, in response to the determination unit determining that the plurality of virtual objects is a specific combination, the plurality of virtual objects based on the information about the plurality of markers received from the image processing apparatus; and
a transmission unit configured to transmit the virtual objects processed by the processing unit to the image processing apparatus.

30. The information processing apparatus according to claim 29, wherein the storage unit stores a virtual object table which associates other virtual objects with the virtual object as recommended virtual objects, and
wherein, based on the virtual object table and the information about the plurality of markers received by the receiving unit, the transmission unit transmits to the image processing apparatus other virtual objects associated with the virtual objects corresponding to the plurality of markers received by the receiving unit, as a recommended virtual object, together with the virtual object corresponding to the marker received by the receiving unit.

31. The information processing apparatus according to claim 30, wherein the recommended virtual object is a virtual object most frequently displayed together with the virtual object.

32. A method to control an image processing apparatus, the method comprising:
acquiring information about a plurality of markers included in an image;
performing control to superimpose on the image and display a plurality of virtual objects corresponding to the plurality of markers; and
determining whether the plurality of virtual objects is a specific combination,
wherein, in response to determining that the plurality of virtual objects is a specific combination, performing control includes performing control to superimpose on the image the plurality of virtual objects in a specific arrangement corresponding to the specific combination.

33. A method to control an information processing apparatus capable of communicating with an image processing apparatus, the method comprising:
receiving information about a plurality of markers included in an image from the image processing apparatus;
storing virtual objects corresponding to the plurality of markers;
determining whether the plurality of virtual objects corresponding to the plurality of markers is a specific combination;
processing, in response to determining that the plurality of virtual objects is a specific combination, the plurality of virtual objects based on the information about the plurality of markers received from the image processing apparatus; and
transmitting the processed virtual objects to the image processing apparatus.

34. A non-transitory storage medium storing a computer-readable program that causes a computer to perform the method according to claim 32.

35. A non-transitory storage medium storing a computer-readable program that causes a computer to perform the method according to claim 33.
